(19) United States
(12) Patent Application Publication
(10) Pub. No.: US 2003/0198521 A1
(43) Pub. Date: Oct. 23, 2003

(54) Enhanced Subtitle D design standard composite liner

(76) Inventor: Pierce L. Chandler JR., Rockwall, TX (US)

Correspondence Address: Pierce L. Chandler, Jr., 1204 Bayshore, Rockwall, TX, 75087, US

(21) Appl. No.: 10/128,157

(22) Filed: Apr. 23, 2002

(51) Int. Cl. B09B 1/00

(52) U.S. Cl. 405/270; 405/129.95; 405/302.7

(57) ABSTRACT

An enhanced composite liner system to be employed under waste management units and comprised of an upper flexible membrane liner component (2), an intermediate bentonite layer component (3), and a lower compacted soil liner component (1). The bentonite layer component (3) is bonded to the flexible membrane liner component (2). The flexible membrane liner component (2) utilizes overlapping seams (4) sealed by the bentonite layer component (3) to join the sheets or panels of the flexible membrane liner. The overlapping seams (4) are arranged shingle fashion in the downslope direction of the liner surface. The use of the bentonite layer component enhances direct and uniform contact between the flexible membrane liner component (2) and the underlying compacted soil liner component (1).

### CROSS-REFERENCE TO RELATED APPLICATIONS

Not applicable

### BACKGROUND

Field of Invention

This invention relates to waste management and particularly to an improved method for waste-containment liner systems to be employed under land-based waste management facilities.

### FEDERALLY SPONSORED RESEARCH AND DEVELOPMENT

This invention was not, in any way, developed as part of federally-funded or federally-sponsored research and development.

Description of Prior Art

Waste management and disposal practice was codified in response to the 1976 Resource Conservation and Recovery Act (RCRA) and the 1984 Hazardous and Solid Waste Amendments (HSWA) to RCRA. In 1991, U.S. EPA promulgated rules for non-hazardous waste management (primarily municipal solid waste) commonly referred to as “Subtitle D” rules to distinguish from Subtitle C or hazardous waste management rules. (Oct. 9, 1991 Federal Register, Volume 56, Number 196). These Subtitle D rules can be found in 40 CFR Parts 257 and 258.

Subtitle D, 40 CFR Part 258, has specific requirements for Municipal Solid Waste Landfills (MSWLF). One of the key requirements is a “liner or lining system” to contain and isolate waste and to prevent migration of waste constituents to groundwater. The liner requirements fell into two categories—a site specific, performance-based design [40CFR258.40(a)(1)] or a design standard composite liner [40CFR §258.40(a)(2)]. The design standard composite liner was defined as: “a system consisting of two components; the upper component must consist of a minimum 30-mil flexible membrane liner (FML), and the lower component must consist of at least a two-foot layer of compacted soil with a hydraulic conductivity of no more than 1×10⁻⁷ cm/sec. FML components consisting of high density polyethylene (HDPE) shall be at least 60-mil thick. The FML component must be installed in direct and uniform contact with the compacted soil component.”

As noted in the Subtitle D preamble, the design standard composite liner was designed to be “protective in all locations, including poor locations.” This protection was the result of the assumed synergy between components resulting from direct and uniform contact. This design standard composite liner system also offered substantive privileges—such as leachate recirculation and exemption from performance demonstration/verification—as compared to performance-based design liner systems.

For all these reasons, new municipal solid waste and/or non-hazardous waste landfills or expansions of existing municipal/non-hazardous landfills since Oct. 9, 1993, have generally utilized design standard composite liners. The “standard-of-practice” uses a 60-mil HDPE flexible membrane liner (FML) with heat-welded seams over a two-foot compacted soil liner. The compacted soil liner is constructed initially. After some interval of time, the flexible membrane liner is installed over the compacted soil liner. This delay is usually the result of seam-welding logistics and the consideration of economy of scale.

The level of environmental protection assumed (in the Subtitle D rules) for the design standard composite liner is not being achieved in that “direct and uniform contact” between liner components is rarely, if ever, being achieved. These failings are the result of:

1) delay in FML component placement which allows degradation, deterioration, and damage to the compacted soil liner component.

2) wrinkling of the FML component when installed over large areas.

3) damage to the FML component from the seam welding and subsequent destructive testing.

As a result of the normal installation practice, almost all synergy between components is lost and leakage through the liner is controlled by defects in individual components. Catastrophic increases in leakage through the FML component can occur as a result of conventional practice and/or FML properties. These problems include:

1) stress cracking of embedded wrinkles in the FML;

2) tearing of the FML due to unrelieved tensile stresses;

3) destructive testing of the FML seams;

4) defects that are not easily repairable and repairs that may be even more defective; and

5) degradation of the compacted soil liner component (and wrinkles in the flexible membrane liner component) preventing direct and uniform contact.

Current design/construction practice also requires high skill and training levels for FML installation—particularly seaming. In addition, the FML component can be easily affected by wind—posing both an installation problem and a personnel injury problem.

For all of these reasons, the Subtitle D design standard composite liner, as currently designed and installed, is inherently flawed and offers inferior protection against releases from the waste management unit and resulting impacts to groundwater. This is particularly troubling, since the use of the design standard composite liner allows siting of landfills in areas with high-resource-value groundwater and little, if any, natural protection to that groundwater.

Prior art for the design standard composite liner specified in 40CFR258.40(a)(2) exists wholly within the public domain since the design was originated by U.S.EPA in response to Federal Legislative requirements. The design standard composite liner was the result of U.S. EPA's continuing design process initiated in the mid 1970's for hazardous waste management. Individual components of the design standard composite liner are also in the public domain. Compacted soil liners have been used since Roman times and have historically been used as the typical liner under waste management units. Flexible membrane liners or FMLs have seen general use over the last thirty years. Research of published information and manufacturer's literature did not reveal any patents. An FML with a layer of bentonite bonded to it is typically referred to as a geosynthetic clay liner or GCL. The GCL has antecedents in products used for waterproofing below-grade structures; however, the GCL was specifically developed and marketed for use as a “alternate liner” to meet the performance-based design requirements of 40CFR258(a)(1). The GCL was intended for use in regions where clay is not readily available, i.e., the GCL was intended to be an alternate for a compacted soil liner. Research on GCLs indicated a number of patents related to manufacturing various GCL configurations such as the bonding of the bentonite, etc. However, the research clearly showed that a GCL component has never previously been combined with a compacted soil liner component for use as a Subtitle D design standard composite liner.

### SUMMARY

The enhanced Subtitle D design standard composite liner described herein was developed to solve design/installation problems inherent in typical Subtitle D solid waste landfill facilities. The enhanced Subtitle D design standard composite liner has the two statutory—required components—a flexible membrane liner (FML) component and a compacted soil liner component. The enhancement comes from utilizing a layer of bentonite between the FML and compacted soil liner components. The bentonite layer is bonded to one side of the FML component. The bentonite layer is used to seal overlapping or “shingled” seams in the FML component. The bentonite layer also ensures direct and uniform contact between the FML and compacted soil liner components. The bentonite layer significantly increases the weight of the FML—reducing the wrinkling potential and wind sensitivity. By incorporating overlapping seams in a “shingle” fashion, buildup of any wrinkles is significantly reduced through seam flexibility. Any small defect in the FML is also repaired by the underlying bentonite layer. Larger defects in the FML component can be easily and effectively repaired. Finally, the enhanced Subtitle D design standard composite liner preserves the compacted soil component properties by allowing near-contemporaneous placement of the FML component with the compacted soil component. The composite liner design described herein offers superior environmental performance by improved resistance to leaking. Any concerns over potential shear strength loss in the bentonite layer due to hydration can be easily addressed by placing a second FML against the bentonite of the original FML component. This second FML effectively “encapsulates” the bentonite to prevent significant strength loss from hydration of the bentonite.

### OBJECTS AND ADVANTAGES

The enhanced Subtitle D design standard composite liner of this invention provides a simpler, more reliable, more easily installed, and higher performance liner system compatible with the requirements (and intent) of the Federal Subtitle D regulations.

The enhanced liner system described herein allows for immediate placement of FML liner components as soon as any area of compacted soil liner component is completed. Because heat-welded seaming and destructive testing of the seams is not required, protective cover can be installed over the FML component immediately. The combination of small area installation, overlap seaming method and expeditious placement of protective cover results in the following advantages:

1) Deterioration/degradation of the compacted soil liner component is minimized to the extent possible by expeditious placement of the FML component.

2) Damage to the compacted soil liner component (and FML component) is minimized by small-area application, and expeditious installation of protective cover.

3) FML component weight, overlap seaming method, and small-area expeditious installation minimize wrinkle potential in the FML component.

4) The bentonite layer will effectively seal any wrinkles and/or wrinkle induced defects that actually occur in the FML component.

5) The bentonite-sealed overlapping seams provide orders of magnitude improvement in leakage rate compared to the currently-used welded seams.

6) The entire lining system can be installed by competent general contractors. Highly-specialized personnel and/or equipment is not needed as in the case of the current Subtitle D installations.

7) Repairs to the FML are simple. Small defects are self-repairing due to the bentonite layer. Larger defects require nothing more than an overlapping patch of FML (with bonded bentonite material) held in place with simple adhesive methods until protective cover is placed. The current Subtitle D system uses welded patches which often have higher leakage rates than the original defect.

8) Destructive testing of FML component seams is eliminated which greatly reduces the defects in the FML. Elimination of the waiting period for destructive testing also minimizes the potential for damage to the exposed FML component.

9) Due to the overlapping, non-welded seams, tensile stress buildup in the FML is minimized.

10) Potential shear strength concerns resulting from the use of the bentonite layer can be easily addressed by encapsulation of the bentonite with an additional layer of FML.

11) The statutory requirements of Subtitle D [40CFR §258.40 (a)(2) and (b)] for a design standard composite liner are specifically met.

### DRAWINGS FIGURES

FIG. 1 is a side view or section of the invention showing all elements of the invention FIG. 2 shows a side view or section of an additional embodiment of the of the invention.

### REFERENCE NUMERALS IN DRAWINGS

1 compacted soil liner component

2 flexible membrane liner (FML) component

3 bentonite layer component

4 overlapped seam

### DESCRIPTION OF INVENTION

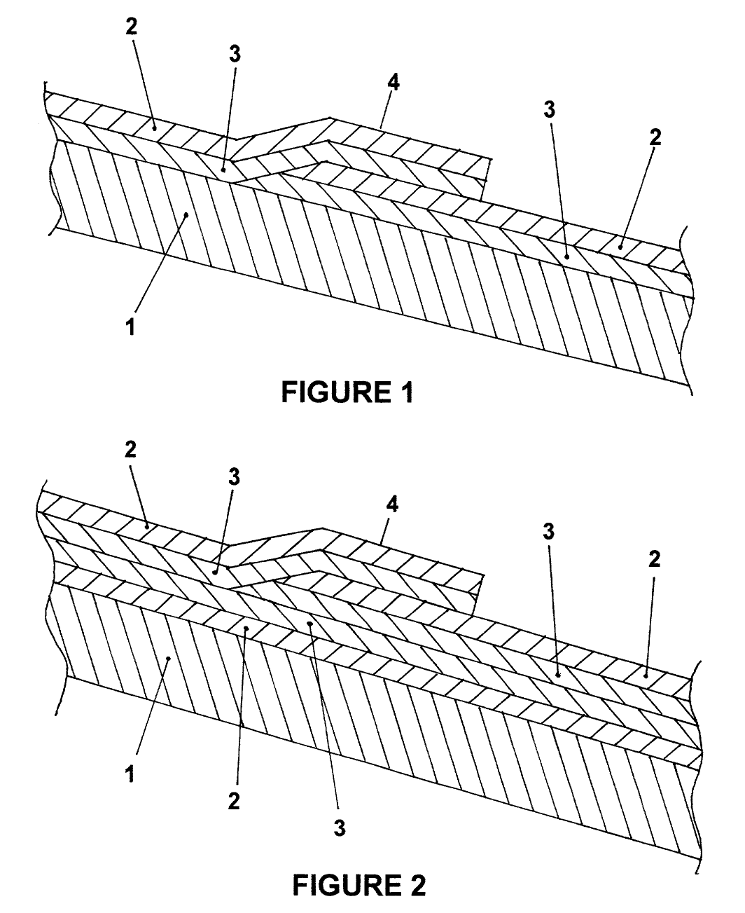

FIG. 1 shows the preferred embodiment. With reference to FIG. 1, a compacted soil liner component (1) is initially constructed on the subgrade. The compacted soil liner is constructed to a minimum thickness of two feet using materials and techniques necessary to attain a hydraulic conductivity of no more than 1×10⁻⁷ centimeters per second.

A flexible membrane liner (FML) component (2) with an intermediate bentonite layer component (3) bonded to the underside is placed over the entire constructed soil liner component (1). The FML/bentonite sheets or panels are successively placed with overlapping seams (4) “shingled” in the downslope direction.

FIG. 2 shows an additional embodiment wherein an additional FML component (2) with bonded bentonite (3) is used. In this embodiment, the additional FML (2) is placed on the constructed soil liner component (1) with the bentonite layer component (3) side up. An FML component (2) with a bentonite layer component (3) bonded to the underside is then placed to complete the installation. The bentonite layer components (3) are thus encapsulated between the FML components (2). This additional embodiment is intended for use where bentonite shear strength loss due to hydration is a concern.

Operation of Invention

With respect to FIG. 1, the flexible membrane liner (FML) component (2) is the primary barrier to any release from the waste management unit. The FML component (2) is practically impermeable to fluid migration.

The bentonite layer component (3) provides an effective method for sealing the overlapping seams (4) in the FML component (2). The bentonite layer component (3) is practically impermeable and provides a secondary barrier to any release from the waste management unit. The bentonite layer component (3) is also effective in sealing small defects in the FML component (2) against any leakage.

The lower compacted soil liner component (1) is the final barrier to any release from the waste management unit. The compacted soil liner component (1) is also practically impermeable.

FIG. 2 shows an additional embodiment for operation in situations where loss of shear strength from hydration of the bentonite layer component (3) may be a concern. Shear strength of the bentonite layer component (3) can be preserved by using an additional FML component (2) between the bentonite layer component (3) and the compacted soil liner component (1). The additional FML component (2) is placed with the bentonite layer component (3) side up. The bentonite layer components (3) are securely encapsulated between FML components (2) and bentonite shear strength loss is minimized.

### CONCLUSIONS, RAMIFICATIONS, AND SCOPE OF INVENTION

The enhanced Subtitle D design standard composite liner of this invention provides a simpler, more reliable, more easily installed, higher performance liner system compatible with the requirements (and intent) of the Federal Subtitle D regulations. The enhanced Subtitle D design standard composite liner described herein specifically meets the statutory requirements of Subtitle D [40CFR §258.40 (a)(2) and (b)] for a design standard composite liner.

The enhanced liner system described herein allows for immediate placement of FML liner components as soon as any area of compacted soil liner component is completed. Because heat-welded seaming and destructive testing of the seams is not required, protective cover can be installed over the FML component immediately. The combination of small area installation, overlap seaming method and expeditious placement of protective cover results in the following advantages:

1) Deterioration/degradation of the compacted soil liner component is minimized to the extent possible by expeditious placement of the FML component.

2) Damage to the compacted soil liner component (and FML component) is minimized by small-area application, and expeditious installation of protective cover.

3) FML component weight, overlap seaming method, and small-area expeditious installation minimize wrinkle potential and enhances “direct and uniform contact” with the compacted soil liner component.

4) The bentonite layer will effectively seal any wrinkles and/or wrinkle induced defects that actually occur in the FML component.

5) The bentonite-sealed overlapping seams provide orders of magnitude improvement in leakage rate compared to the currently-used welded seams.

6) The entire lining system can be installed by competent general contractors. Highly-specialized personnel and/or equipment is not needed as in the case of the currently-used composite liner installations.

7) Repairs to the FML component are simple. Small defects are self-repairing due to the bentonite layer. Larger defects require nothing more than an overlapping patch of FML (with bonded bentonite material) held in place with simple adhesive methods until protective cover is placed. This patching method eliminates the currently-used welded patches which often have higher leakage rates than the original defect.

8) Destructive testing of FML component seams is eliminated which greatly reduces the defects in the FML. Elimination of the waiting period for destructive testing also minimizes the potential for damage to the exposed FML component.

9) Due to the overlapping, non-welded seams, tensile stress buildup in the FML component is minimized.

10)Potential shear strength concerns resulting from the use of the bentonite layer can be easily addressed by encapsulation of the bentonite with an additional layer of FML.

Although the preceding discussions provide specific details, these specific details should not be construed as limiting the scope of this invention but simply as an example of the preferred embodiments of the invention. Thus the scope of this invention should be determined by the attached claim and its legal equivalent, rather than by the examples given.

I claim:

1. An enhanced composite lining system comprised of natural and synthetic components to be employed under waste management units to prevent releases.

2. The enhanced composite lining system of claim 1 utilizing a flexible membrane liner (FML) of synthetic material as the uppermost liner component.

3. The synthetic flexible membrane liner component of claim 2 having a predetermined thickness of at least 30 mils.

4. The synthetic flexible membrane liner component of claim 2 being in panels or sheets of predetermined length and width.

5. The synthetic flexible membrane liner component of claim 2 being placed with overlapping seams and shingled in the downslope direction.

6. The synthetic flexible membrane liner component of claim 2 being a primary lining system barrier to any release from a waste management unit.

7. The synthetic flexible membrane liner component of claim 2 having a layer of bentonite bonded to one side to provide a means for sealing seams and minor defects and allowing simple, efficient patching.

8. The bonded bentonite layer of claim 7 having a predetermined thickness.

9. The bonded bentonite layer of claim 7 functioning as an Intermediate liner component.

10. The bonded bentonite layer component of claim 7 providing a secondary lining system barrier to any release from a waste management unit.

11. The use of an additional, optional synthetic flexible membrane liner component against the bonded bentonite layer component of claim 7 providing for encapsulation of the bentonite, where needed, to prevent strength loss of the bentonite.

12. The enhanced composite lining system of claim 1 utilizing a compacted soil liner as the basal liner component.

13. The compacted soil liner component of claim 12 having a predetermined thickness of at least two feet.

14. The compacted soil liner component of claim 12 having a predetermined hydraulic conductivity of no more than 1×10⁻⁷ centimeters per second.

15. The compacted soil liner component of claim 12 as being the final lining system barrier to any release from the waste management unit.
Whereby: the liner system under waste management units is enhanced; waste is more securely contained; leakage from waste management units is minimized; the most stringent regulatory requirements (and intent) of Subtitle D are met; liner system constructibility is improved; and threat and/or risk to human health and the environment is minimized.
